(19) United States
(12) Patent Application Publication
(10) Pub. No.: US 2014/0260019 A1
(43) Pub. Date: Sep. 18, 2014

(54) Drywall Corner Bead

(71) Applicant: John S. Conboy, Chesterfield, MO (US)

(72) Inventor: John S. Conboy, Chesterfield, MO (US)

(21) Appl. No.: 13/839,675

(22) Filed: Mar. 15, 2013

(51) Int. Cl. E04F 13/06; C09J 5/00; B29C 53/02; B29C 51/00; B29C 59/00

(52) U.S. Cl. CPC E04F 13/06; B29C 51/00; B29C 59/00; B29C 53/02; C09J 5/00
USPC 52/255; 264/134; 427/203

(57) ABSTRACT

A corner bead for wallboard applications comprising a polymeric core having a bonding surface for bonding to wallboard wherein the bonding surface has applied thereto a water activated adhesive which is bonded to the polymeric core by a curable adhesive having embedded therein fibers which are also embedded in the water activated adhesive.

### FIELD OF THE INVENTION

This invention relates to drywall corner beads, and particularly to a polymer-based, self-sticking drywall corner bead.

### BACKGROUND OF THE INVENTION

Over the years, drywall corner beads have been made in several configurations and materials. Specifically, corner beads have been made from paper/steel, stainless steel, galvanized steel, aluminum, and polyvinyl chloride. Each material has its own benefits and detriments, and certain drywall installers have their own preferences.

For exterior corners, metal corner beads have enjoyed substantial popularity; however, these corner beads suffer from a number of various deficiencies, not the least of which is the need for multiple applications of substantial amounts of drywall compound to be applied to the corner bead in order to provide a smooth wall transition from the wallboard to the corner bead. Additionally, because of their rigidity, metal corner beads have less of a tendency to follow unevenness in the wallboard surface, manifesting in gaps between the end of the corner bead and the underlying wallboard surface: this especially so where a flange of the corner bead rides over a seam between adjacent wallboard pieces. These instances also require the additional applications of drywall compound. Finally, corner beads are typically mechanically fastened to the wallboard or, more commonly, the framework behind the wallboard. This too requires additional drywall compound to mask the mechanical fastener head and, where the mechanical fastener is fasted to the framework, oftentimes leads to create cracking problems in the finished seam owing to, among other sources, expansion/contraction of the wallboard, settling of the framing, etc.

Additionally, corner beads, whether metal, plastic, paper, paper composite, etc., oftentimes suffer from detachment from the underlying wallboard. This is particularly so where the corner bead is placed against the wallboard and drywall compound is applied over the bead and adjacent wallboard whereby the drywall compound layer holds the bead to the wallboard or, if an insufficient amount of drywall compound is applied to the wallboard or inside of the bead prior to placement of the bead on the wallboard such that the drywall compound does not fully cover the interface between the bead and the wallboard.

Paper and paper composite beads have additional problems or shortcomings One is the generation of fibrils in the paper should the installer accidently sand into the paper during the sanding and finishing process. There fibrils give a “fuzzy” surface texture to the corner bead which must be worked out or repaired through further applications of drywall compound or sanding after painting the surface of the dried drywall compound. Additionally, with paper and paper composite beads there is a concern with respect to water absorption by the paper and the resultant softening of the corner bead. In certain instances this can lead to deformation of the corner bead during the application and clean-up process to remove excess drywall compound or as a result of someone or something bumping into the corner before the drywall compound dries. In other instances, the installer's applicator tool or knife can accidently cut or tear into the paper as the installer attempts to clean the edge of the corner bead with the sharp applicator tool following application of the drywall compound to the surface of the corner bead.

To avoid the problems with lack of adherence of the corner bead to the underlying wallboard and/or the need for mechanical fasteners, advances have been made in corner bead technology whereby the corner beads are adhesively affixed to the wallboard. One type of adhesive bead employs a pressure sensitive or tack adhesive which is pre-applied to the mating surface of the bead and a liner material laid over the adhesive to prevent it from bonding until desired. To install this corner bead one merely removes the liner and places the bead on/in the corner to be filled. The problem with this type of adhesive bead is that the bead cannot be moved or adjusted once placed: any effort to remove or reposition the bead results in a tearing of the paper of the wallboard, creating additional imperfections that must be repaired.

A second type of adhesive bead uses a spray-on adhesive; however, extreme care must be taken in spraying the adhesive so as to provide a thin, uniform film of adhesive to the bead. Too much adhesive and the adhesive will flow out from between the bead and wallboard on application of the bead. Too little and the bead may not properly adhere to the wallboard causing the bead to lift during or subsequent to finishing. Of course, spray-on adhesive also requires precision in application in order to avoid the mist or spray of adhesive from contacting other surfaces. Furthermore, these adhesives tend to be based upon volatile, organic solvents and aerosols: non-desirable materials in todays ecco-sensitive marketplace.

Yet another adhesive bead employs a water activated adhesive. Here a water activated/water soluble adhesive is activated by applying a spray of water to the surface of the bead having the adhesive pre-applied thereto. While certainly advantageous to the instant adhesives and solvent based adhesives, they are not without their concerns as well. This is particularly so with respect to the proper activation of the adhesive: both in terms of sufficient coverage and wetting as well as sufficient timing to allow proper activation before applying the bead to the wallboard. If too little water is applied to the bonding surface or the bonding surface of the bead is not completely covered with water one is left with a bead that will not fully adhere to the wallboard across the whole of the interface surface area. Similarly, if the water is not allowed to sit long enough to provide sufficient penetration into the adhesive, too little adhesive may be activated and the resultant bond formed may be weak. In both instances, one may realize separation of the bead from the wallboard during or subsequent to finishing. The problems are exacerbated in the case of paper and paper composite beads where, as noted above, too much water results in a loss of integrity and/or shape to the bead.

Finally, in those instances when the adhesive is applied to a paper bead or the paper flanges of a composite bead, when the adhesive and wetted paper dries or partially dries prior to application of the bead to the wallboard, the paper has a tendency to curl up, making it useless or requiring a full re-wetting and re-forming. Similarly, following application of the bead to the wallboard, should the paper or paper composite bead be wetted to the point where the adhesive is sufficiently softened, the bead may move and/or the edges of the paper bead have a tendency to curl up as the adhesive once again dries. In these instances, the bead may become useless or, if already applied to the wallboard, must be removed or extensive repair done to lay the edges of the bead flat.

Thus, despite all the advances, there is still a need for a self-adherent corner bead which has more consistent and reliable activation and which does not allow for curling and/or loss of structural integrity of the bead, even with wetting, and does not suffer from “fuzzing up” when sanded.

### SUMMARY OF THE INVENTION

The present invention is directed to a corner bead for wallboard applications comprising a) a thin, elongated polymeric strip-like body having two surfaces, a bonding surface for mating with a wallboard substrate and an exposed surface facing away from the wallboard when mated, b) a layer of discrete fibers adhered to at least a portion of the bonding surface of the polymeric body and c) a water activated adhesive applied to the layer of discrete fibers on the bonding surface. Optionally, though preferably, the layer of discrete fibers is also adhered to at least a portion of the exposed surface as well.

The elongated polymeric body has a longitudinal axis, generally along the centerline of the polymeric body, about which, preferably, the polymeric body is flexible and/or partially folded, the extent of the fold depending upon, in part, the specific end-use application for the bead: each folded portion comprising a flange. Typical pre-set angles of the fold are about 90° and 130°, generally ±5°, minus in the case of exterior corner beads and plus in the case of interior corner bead. Most preferably, the polymer body will have a pre-set fold yet is still flexible about the longitudinal axis whereby a given body may be used for multiple applications having various angle requirements as well as to account for imperfections in alignment of walls and corners. Flexibility is typically such that the corner beads may be applied to corners having angles of from 70° or less to 160° or more.

Most preferably, the polymeric body is has a thinner fold region along the longitudinal axis which allows for improve flexibility for folding the corner bead about the longitudinal axis. The thinner thickness of the fold region may be molded or extruded into the strip of polymer material or it may be embossed into the material. In addition, or in the alternative, it is most preferable that the fold region be associated with or have incorporated therein a protrusion running along the longitudinal axis, which protrusion, when the corner bead is laid flat on a planar surface, rises above the plane of the corner bead flanges. The protrusion, extending away from the exposed surface in the case of a bead to be applied to an outer corner and away from the bonding surface in the case of a bead to be applied to an inner corner. Furthermore, in the case of exterior corner beads, the protrusion may incorporate a bead of a curable adhesive, sealant or caulking material to add additional strength to the corner element.

### DESCRIPTION OF THE DRAWINGS

FIG. 1 is an elevated, angled side view of a portion of a corner bead for application to an exposed corner according to one embodiment of the present invention.

FIG. 2 is a cross-sectional view of the corner bead of FIG. 1 along the line 2-2.

FIG. 3 is close-up view of that portion of the corner bead of FIG. 2 in bubble A.

FIG. 4 is an elevated, angled side view of a portion of a corner bead for application to an inner corner according to another embodiment of the present invention;

FIG. 5 is a cross-sectional view of the corner bead of FIG. 3 along the line 5-5.

FIG. 6 is close-up view of that portion of the corner bead of FIG. 5 in bubble B.

FIG. 7 is a close is close-up view of that portion of the corner bead of FIG. 5 in bubble C.

FIG. 8 is an elevated section view of a corner bead in a flattened state according to an embodiment of the present invention;

FIG. 9 is an elevated section view of a corner bead in a flattened state according to another embodiment of the present invention.

FIG. 10 is a cross-sectional view of a corner bead according to yet another embodiment of the present invention.

FIG. 11 is a schematic flow diagram of a continuous process for making a corner bead according to one embodiment of the present invention;

### DESCRIPTION OF THE PREFERRED EMBODIMENT

According to the present invention there is provided a corner bead for wallboard applications comprising a) a thin, elongated polymeric strip-like body having two surfaces, a bonding surface for mating with a wallboard substrate and an exposed surface facing away from the wallboard when mated, b) a layer of discrete fibers adhered to at least a portion of the bonding surface of the polymeric body and c) a water activated adhesive applied to the layer of discrete fibers on the bonding surface. Most preferably, a layer of discrete fibers is also adhered to at least a portion of the exposed surface as well.

The first component of the corner bead is the elongated polymeric body. The polymeric body provides structural integrity to the corner bead and serves as the foundation upon which the other components of the corner bead are applied. Generally speaking this is a strip of a polymeric material having a longitudinal axis running the length of the strip, which typically coincides with its centerline, i.e., the mid-point between the longitudinal edges of the polymeric body. However, it is also to be appreciated that the longitudinal axis may be offset from the centerline of the length of the strip, whereby the strip, when folded about its longitudinal axis, will have a wider flange on one side than the other.

The polymer materials used in manufacturing the elongated polymeric body is preferably an injection moldable or extrudable thermoplastic material. Exemplary polymers include, but are not limited to, polypropylenes, polyethylenes, polystyrenes, nylons, polyethers, polyesters, polycarbonates, vinyl polymers, as well as copolymers and polymer blends thereof. Especially preferred polymers include polyvinylchloride, polyethylene, polypropylene, polyethylene terephthalate; most especially polyvinylchloride. Furthermore, the thermoplastic may be filled and/or fiber reinforced for added strength and/or rigidity, as necessary. All of such materials are well known and widely available. Furthermore, two or more different, though compatible, polymers may be used to produce the polymeric body with a more flexible polymer in the longitudinally central region, i.e., the fold region, of the polymeric body and a more rigid polymer in the edge or flange regions of the polymeric body. Such polymers may be of the same family or different families, so long as they form a strong weld like when cooled.

Manufacture of the elongated polymeric body may be by molding, where defined lengths are prepared, or by extrusion (or pultrusion if longitudinal reinforcement is also desired, co-extrusion in the case of two or more polymers being extruded side-by-side). The strip may be formed as a flat strip or it may be molded or extruded into a defined shape: the shape corresponding to the extrusion die. The strip is typically from about 2″ to about 5″, preferably from about 2.5″ to 4.5″, in width and has a thickness of from about 0.010″ to about 0.060″, preferably from about 0.20″ to about 0.040″. Most preferably, the thickness of the strip along the longitudinal axis, i.e., the fold region, is thinner than that to either side of it: this is particularly beneficial where the polymer material of which it is made is more rigid: the thinner material improving the flexibility of the strip about its longitudinal axis. Where such a thinner fold region is present, its width is typically from about 0.005″ to about 0.10″, preferably from about 0.005″ to about 0.08″, and its thickness is from about 0.004″ to about 0.020″. It is to be appreciated that these numbers pertain to the width of the embossing or immediate peak of the protrusion and not to the total width of the fold region which may include indentations and the like. Generally, the fold region as a whole may be up to 0.5″ or more in width. Alternatively or in addition thereto, the thickness of the strip may have a slight taper as one moves across the width of the tape in opposing directions from the longitudinal axis to the longitudinal edges. The extent of the taper (i.e., the difference between the thickest region at or near the longitudinal axis and the thickness of the strip at the edge), if present, is from about 0.010″ to about 0.060″. The thinner fold region along the longitudinal axis may be directly molded or extruded into the strip. Alternatively, it may be embossed into the strip, e.g., by plastic deformation. Embossing or plastic deformation may be performed with or without heat; though, as thermoplastic materials, the deformation will be much easier and create less stresses in the polymeric material if done at or near the softening point of the thermoplastic polymer.

Although, as noted, the strip may be formed as a fiat or relatively flat strip, it is preferably formed into an angled strip, the strip being folded about its longitudinal axis, most preferably along its centerline. Typically, the strips are folded at pre-set angles; though most preferably, they are still flexible enough about their longitudinal axis to allow for further contraction or expansion of the angle. The most common pre-set angles are about 90° and about 130°, generally ±5°, minus in the case of exterior corner beads and plus in the case of interior corner bead. Most preferably, the polymer body will have a pre-set fold yet is still flexible about the longitudinal axis whereby a given body may be used for multiple applications having various angle requirements as well as to account for imperfections in alignment of walls and corners. Flexibility is typically such that the corner beads may be applied to corners having angles of from 70° or less to 160° or more: though it is to be understood that a single corner bead may not accommodate that full range of angles and, accordingly, it may be preferable to manufacture corner beads of two or more pre-set angles which then accommodate the full range of applications.

Optionally, though preferably, the flanges of the corner beads will also have a multitude of holes passing through the body of the flanges. The holes are preferably not in the fold region and are set back from the longitudinal edges so as not to intersect with the outer edges of the strip. Most preferably, the holes lie in that region of the flange between the edges and an imaginary line that is parallel with the longitudinal axis and lies about 80%, preferably about 65%, of the distance from the edge to the longitudinal axis. The holes may be round, ovoid, elliptical, square, rectangular, etc., and may be arranged in a set array or grid or randomly set. Preferably the holes are arranged in a staggered array whereby lines of holes parallel to the longitudinal axis are offset from one another by half the distance between adjacent holes in each line. The holes may range from pinhole size up to about 0.25″ in diameter, preferably from about 0.08″ to about 0.2″ in diameter. In the case of elliptical or rectangular holes, the aspect ratio is typically from about 1.1:1 to 10:1 (largest dimension:shortest dimension) with the major axis being up to about 0.5″ in length, preferably up to about 0.4″ in length. Additionally, the holes are spaced such that the surface area of the region of the flange in which the holes lie, i.e., that between the edge and the imaginary line noted above, is at least 30%, preferably at least 40%, most preferably at least 50% voids or holes. Besides providing a point of contact between the underlying wall board and the drywall compound to be applied over the corner bead, the holes also add additional, multidimensional flexibility to the flange material allowing it to more readily follow the contours of the wallboard surface to which it is applied. Preferably, the holes are elliptical in shape and arranged in a staggered array. Especially preferred elliptical holes are 0.32″ in length and 0.08″ in width. This configuration and arrangement provides improved flexibility and avoids issues with drywall compound peaking/backing out of the holes as the applicator tool swipes across the holes.

The holes may be molded into the strip or, more commonly, are punched into the flanges following formation of the strip. Punching of the holes may take place at any point in the process for producing the corner beads, but is most preferably done following the application and drying of the water activated adhesive.

Optionally, though preferably, the strip also has an embossing and/or at least one protrusion in the fold region, most preferably one running along the longitudinal axis itself and serving as the fold seam or line. Simple embossing merely thins the polymer in the region of the embossing without or with minimal impact on the opposing surface of the polymeric body. On the other hand, protrusions are such that when the flanges are opened to 180°, the protrusions stand above and/or below the plane of the flanges. A cross section of the protrusion may have a “V” shape, a “W” shape (i.e., two peaks standing above one surface and a single peak above the other surface), a “U” shape, etc. The protrusions may be molded or extruded into the strips or it may be thermoformed after the strip is made. For example, the protrusion may be formed concurrent with the thinning of the fold region by e.g., embossing or continuous thermoforming. Here the formation of the protrusion inherently thins the thickness of the strip in the region of the protrusion. Generally speaking, the protrusions will stand about 0.010″ to 0.050″, preferably from about 0.020″ to about 0.040″ from the planar surface of the flanges when opened to 180°. As noted below, when a single protrusion exists, it will typically stand above or extend from the exposed surface in the case of an exterior corner bead and from the bonding surface in the case of an interior corner bead.

The second component of the corner bead is the layer of fibers adhesively bonded to at least a portion of the bonding surface and, optionally, though preferably, the exposed surface. Most preferably, this layer is applied so as to cover essentially the entirety of both sides of the flanges, but is preferably not applied to that portion of the flanges in the fold region or, if so, is not applied along the longitudinal axis or seam of the fold or the protrusion, if present. Application of the layer of fibers to the exposed surface not only improves the adhesion or bond of the drywall compound to the corner bead but is also found to prevent successive windings, in the case of rolled product, or stacked strips from sticking together in high humidity conditions as may be experienced in storage and transport. In any event, whether applied to just the bonding surface or both the bonding and exposed surfaces, this layer is preferably formed by applying a curable adhesive to the area to be covered, dusting the uncured adhesive with a thin layer of fibers or fibrils whereby at least a portion of the fibers set into the curable adhesive, and curing the curable adhesive. Optionally, though preferably, the intermediate product so formed is then lightly brushed and/or subjected to a stream of forced gas, preferably air, as with a fan, to remove loose fibers that have not adhered to the cured adhesive. While this process results in some of the fibers being fully embedded in the cured adhesive, a substantial portion of the fibers have ends which protrude from the cured adhesive: the other end being embedded in the cured adhesive.

The first step in the preparation of this layer is the application of the curable adhesive. Suitable curable adhesives are well known: the selection thereof depending upon the composition of the polymeric body. Specifically, one must select a curable adhesive which is compatible with and/or will form a strong adhesive bond to the polymer of the polymeric body. Preferably, the cured adhesive is water resistant and, most preferably, is a cross-linkable adhesive. Exemplary adhesives include acrylic/acrylate adhesives, epoxies, urethanes, urea-formaldehyde adhesives, polyvinyl acetates, polyester adhesives, polyvinylchloride adhesives, and the like. The curable adhesive may be rolled, brushed, sprayed, printed, etc., onto the flanges of the polymeric body. Generally, the rate of application is such as to provide a thin, even coat of the adhesive on the flanges. Typically the thickness of the adhesive layer is from about 0.002″ to about 0.0325″, preferably about 0.002″ to about 0.02″, more preferably about 0.003″ to about 0.01″ and most preferably about 0.005″. Depending upon choice of the adhesive, cure may be effected by, e.g., solvent evaporation, heat, light, moisture, and the like. Finally, while these materials are characterized as adhesives, those skilled in the art will appreciate that these “adhesives” may be coatings, embedding compounds, and the like so long as they adhesively bond to the underlying surface of the flanges and are curable.

Once applied, the uncured adhesive is then dusted with fibers: the amount applied typically being that which is sufficient to lightly, though preferably entirely, coat the adhesive. More can be applied, but is wasted as the non-bound fibers are removed and, most often, discarded. Conversely, while it is not necessary to coat the whole of the adhesive surface, if too light of a coating of the fibers is applied, most all of them are embedded in the uncured adhesive leaving few to protrude from the adhesive following cure of the adhesive and/or too few to enhance the bonding of the curable adhesive to the drywall compound, in the case of the layer applied to the exposed surface of the corner bead, if present, or to the water activated adhesive in the case of the layer applied to the bonding surface. In both instances, the adhesive bond between the curable adhesive and drywall compound or between the curable adhesive and the water activated adhesive, respectively, is supplemented by a mechanical securing of the fibers in each of materials in each of the adjoining layers.

The fibers may be applied as discrete fibers, fibrils, tufts, and combinations of any two or all three. Preferably, a substantial portion is applied as individual or discrete fibers or fibrils. Any fibrous material may be used, including natural and synthetic fibers such as those composed of nylon, rayon, Dacron, polyester, cotton, wool, other cellulosic fibers, as well as combinations of any two or more of the foregoing, and the like. Especially preferred fibers are those comprising a water absorbing material or those that demonstrate water wicking properties, as well as combinations thereof with each other and/or with other non-water absorbing or water-wicking fibers and fibrils. The water absorbing fibers include natural fibers, especially, cotton, wool, fluff pulp, and other cellulosic based fibers, as well as synthetic fibers such as certain acrylic, polyester, polyethylene and polyamide fibers known for water absorption. Fibers that do not absorb water but wick it are those where the water wicking properties are due to the fibers constituting a plurality of fibrils whereby the interstitial spaces between the fibrils wicks the water into and through the fiber. Such water absorbing and water wicking fibers are known and widely available. The fibers and fibrils themselves generally range in size from about 1 to about 3 deniers in diameter and from about 0.005″ to about 0.030″ in length.

The final critical component of the corner beads of the present invention is the water activated adhesive. Water activated adhesives are also well known and widely available. Exemplary water activated adhesive include, but are not limited to, those adhesives comprising or based on methyl cellulose, polyvinyl alcohol, starches, mucilage, gum Arabic, dextrin and the like. Like the curable adhesives described above, the water activated adhesives, typically as an aqueous solution or emulsion, is applied by rolling, brushing, spraying, printing, etc., onto the surface of the fiber coated flange to be mated to the wallboard, the bonding surface. Generally, the rate of application is such as to provide a thin, even coat of the adhesive on the flanges. Typically the water activated adhesive layer is from about 0.002″ to about 0.0325″, preferably about 0.002″ to about 0.02″, more preferably about 0.002″ to about 0.01″ and most preferably about 0.006″. These water activated adhesives set by evaporation of the water leaving the water activated adhesive as a dry-to-the touch, non-tacky surface.

Although not necessary, it is desirable for at least some of the fibers and fibrils to intersect, protrude from, or be dose to the exposed surface of the water activated adhesive. Surprisingly, it has been found that these fibers, especially those that are water absorbing and/or water wicking, hasten the wetting and activation of the water activated adhesive: shortening the wait time before application to the wallboard and improving the extent of activation. It is believed that this occurs as a result of these fibers serving as absorbents to capture water applied to the surface of the water activated adhesive layer before it is able to run off and then serve as transports or pathways for delivering water into the matrix or depth of the water curable adhesive: in essence the fibers wick the water into the adhesive. In the absence of such fibers, activation into the depth of the adhesive is only achieved by the natural migration or saturation of the water into the adhesive from the wetted surface. Additionally, in the absence of these fibers, if insufficient water is applied to the surface and/or absorbed (e.g., by run off), poor or little activation may be achieved. In contrast, the fibers and fibrils of the present invention readily absorb water, capturing it so that it cannot run off before activation is achieved.

Additionally, while it is acknowledged that water activated adhesives have been applied to cellulosic based corner beads, as noted in the background, such corner beads suffer from many deficiencies that the user of polymeric based corner beads overcome. Up to now, however, water activated adhesives have not been used with polymeric based corner beads due to the tendency of water activated adhesives to have poor adherence to the various polymers used to make the polymeric based corner beads, especially the low surface energy polymers like PVC, polyethylene and the like. Surprisingly, this problem is overcome by the present use of the combination of the curable adhesive, which has good adherence to the polymer material, and the water activated adhesive, which has good adherence to wallboard. While it is preferable and desirable that the curable adhesive and the water activated adhesive show good bondability to each other, such is less critical in light of the presence of the fibers which, according to the present teachings, are mutually embedded in the curable adhesive and the water activated adhesive to mechanically lock the two layers together. Thus, an additional benefit of the present teachings is that one is able to produce water activated adhesive corner beads having polymeric cores or bases.

As yet another enhancement to the present invention, one may treat the bonding surface of the corner bead with a water activated/responsive color indicator or incorporate a water activated/responsive color indicator into the water activated adhesive and/or into the composition of the fibers or the same may be treated with such an agent. With respect to the former, the indicator or indicator composition may be incorporated into an ink that is applied to the bonding surface, including an ink that may be used to apply appropriate indicia to the corner bead. Such indicators are compounds and/or compositions which effect a change in their own color or, more typically, the solution in which they are present, e.g., water, when in the presence of moisture and/or a condition affected by or induced by the presence of moisture, e.g., pH. Because the water activated adhesive of the present invention is applied as a water based solution, it is necessary that the indicators to be used are applied after drying or setting of the water activated adhesive or, more preferably, are capable of either changing color again upon drying or of having the color change reversed when dried. Relative to the latter, it is to be appreciated that a color change reversal of certain compounds is effected and/or induced by other means, e.g., phenolphthalein will change the color of a solution under given pH conditions which color change is reversible by light exposure. Hence, in the production of the instant corner bead, once the water activate adhesive is dried, the bonding surface of the corner bead could be subjected to those conditions which reverse the color change (e.g., expose the bonding surface to light in the case of phenolphthalein) so that when the corner bead is rewetted for application, the color change will once again be effected.

Color indicators are well known and their adaption to the present application is well within the skill of one or ordinary skill in the art having the benefit of the present teachings. For example, the indicator may be a water soluble compound, especially a salt, e.g., a metal salt (e.g., white copper sulfate), which causes a visible color change upon dissociation of the salt in water, which color change alters or fades as the salt reforms as the water evaporates. Additional exemplary water activated indicators include phenolphthalein; phenolsulfonephthalein; thymolphthalein; anionic indicators such as bromothymol blue, thymol blue, m-cresol purple, xylenol blue, xylenol blue, xylenol orange, phenol red, and combinations thereof; thermochromic color indicators as disclosed in U.S. Pat. No. 6,228,804—Nakashima, the contents of which are hereby incorporated herein in their entirety by reference. Additionally, the indicator composition may include an inorganic filler such as silicon dioxide, especially amorphous silica; titanium dioxide; or calcium carbonate as these fillers are known to enhance color intensity, especially of the anionic indicators.

The benefit of employing color indicators is that one is readily able to determine whether the corner bead has been sufficiently wetted during the installation process. Depending upon where and how the water activated coloring agent is incorporated into the corner bead, as well as the selection of coloring agent itself, a deepening of the color or color change will also provide an indication as to the degree or extent to which the water activated adhesive is activated and whether or not it is then ready for use.

Furthermore, while the use of indicators is described in the context of the corner beads of the present invention, this inventive use of indicators is applicable to all forms of wallboard tapes and corner bead having a water activated adhesive. For example, these indicators are useful in water activated tapes and corner bead based on paper, paper composites, metals, etc.; all of which are well known and widely available. Accordingly, the present invention also pertains to the use of such indicators in water activated wallboard tapes and corner beads generally.

Those skilled in the art, in light of the teachings presented in this application, will readily appreciate that the corner beads may be made in a number of ways; but are most suitable for batchwise or continuous processes. The former entails employing molded strips or cut strips of the polymeric material whereas the latter, which is most economical, directly integrates the formation of the polymeric strip into the process or employs a continuous preformed polymeric strip that is presented in stock rolls of material.

According to the present teachings, whether batch processing or continuous processing, a liquid curable adhesive is applied to one or, preferably, both sides of the flanges of the strip of polymeric material following which fibers are applied to the surface of the uncured adhesive to provide a light even coating or dusting of the fibrous materials. This step of the process may be performed on the bonding surface of the polymeric body or, if desired, simultaneously on both the exposed surface and the bonding surface of the polymeric body or it may be performed on one side and then the other before curing the curable adhesive. Alternatively, this process may be performed in any of a number of sequential steps. For example, one may apply the adhesive, dust with the fibers and cure on one surface before subsequently repeating the process on the other. Alternatively, one may apply the curable adhesive to one surface and then the other before dusting the uncured adhesive with the fibers on one side before the other and then curing the adhesive on both sides simultaneously. Other sequences are also contemplated: the exact sequence and process depending, in part, upon the equipment used, the spatial limitations on the processing floor, etc.

Following cure of the curable adhesive, a water activated adhesive is then applied as a thin continuous or discontinuous film to that surface of the cured curable adhesive on the bonding surface and allowed to dry. Drying may be through natural evaporation or may be sped up by use of heat and/or airflow.

Following application and drying of the water activated adhesive one may emboss the fold region and/or form a protrusion along the longitudinal axis which then becomes the fold seam or line. The embossing and/or formation of the protrusion typically results in a thinning of the polymeric material in the fold region and facilitates the folding of the corner bead about the longitudinal axis. Embossing and/or formation of the protrusion may be performed by one or more roller elements, especially a plurality of press rollers, most preferably heated press rollers. Where a protrusion is to be formed, the press rollers will have mating male and female surface features corresponding to the protrusion to be impressed or embossed into the strip of the polymeric material. It is also to be noted that such thinning and/or protrusions may be formed directly into the strip of polymeric material as it is being formed, either by way of the die in the case of an extruded polymeric strip or the mold in the case of a molded polymeric strip.

Additionally, if desired and not already present, the strip of polymeric material may pass through a die cut mechanism which punches holes through the flanges. Alternatively, or in addition thereto, the strip may also be passed through a fold former, which folds the strip along its longitudinal axis to the desire angle for the finished product. Preferably, this is done with a plurality of press rollers, most preferably heated, or a number of guide and fold elements. Generally, though, those skilled in the art will readily appreciate other methods for imparting the fold to the strips.

Finally, the formed corner bead is then wound or spooled about a mandrel or spool element for storage and/or packaging. Each winding is of a defined length with the strip of material being cut once the desire length is wound and the cut end being directed to a new spool or mandrel for winding. Depending upon the flexibility and memory of the material in the fold region, the winding may be of the corner bead in a flattened state or it may be wound in the folded state. Alternatively, particularly if the corner bead is of limited flexibility across its width, i.e., perpendicular to its longitudinal axis, the corner bead stock material may be precut into defined lengths which are then stacked. Of course, where the strips are processed in defined lengths, as in a batch-wise processing, again the finished strips of corner bead are stacked.

The corner beads according to the present teachings are simple to use, consistent with other corner beads having a water active adhesive on their bonding side. Specifically, one simply cuts the strip of corner bead to the desire length, applies water to the bonding surface, allows for the water to penetrate and activate at least the surface of the water activated adhesive and then mounts the corner bead to the corner to be finished. As noted above, the wait time for activation of the water activated adhesive is relatively short, typically from about 20 seconds to about 60 seconds, preferably from about 30 seconds to about 45 seconds. Depending upon the water absorbing characteristics of the water activated adhesive, times on the lower end of these ranges, even below these ranges, are suitable when the fibers are of a water absorbing and/or wicking material. Once activated, the corner bead is then firmly pressed to the wallboard and allowed to set in place. Thereafter, drywall compound is applied over the corner bead and adjacent wall board to make the corner bead flush with the wallboard. As the drywall compound is being applied, it is pressed into the holes of the corner bead, if present, to provide an additional, mechanical attachment of the corner bead to the wallboard. Optionally, though typically, the first application of drywall compound is sanded after drying and a second layer applied, dried and sanded, to provide a more class A finish to the wallboard corner.

To further expand the types of exterior corner beads that may be formed in accordance with the present teachings, it is to be appreciated that the protrusion along the longitudinal axis may be sufficiently wide and deep (having dimensions even greater than those noted above for the embossing and protrusions) to accept a bead of a curable adhesive or sealant, especially a hot melt adhesive, caulk, or high viscosity, room temperature curing adhesive, most especially a polymeric or polymer forming material having a degree of resilience, especially a polyurethane. This bead adds extra strength and durability to the nose or peak of the corner bead so that once in position on the wallboard, it protects the corner from deformation and damage in use.

Having described the inventive corner bead and its preparation and application in general terms, attention is now drawn to the accompanying figures. In the figures, the same numerical designations are used to denote the same elements from one figure to the next. Furthermore, it is to be appreciated that these embodiments are exemplary and not limiting. In this respect, since there are multiple elements and features to each of the embodiments presented in the figures, it is also to be understood that any one embodiment of a corner bead according to the present teachings may use any alternative of each element with any alternative of a second or third element. In essence, the elements, features, and the like as set forth above are interchangeable, individually or in plurality, from one figure to the next. Finally, for convenience and simplicity, particularly where the objective of the figures is to show the various structural configurations and designs independent of the specific layers comprising the corner beads, the individual layers are not specifically identified or depicted: though they are understood to be present. This is particularly so for FIGS. 7, 9 and 10. Finally, although the figures show the layer of adhered fibers on the exposed surface as well, it is to be appreciated that no such layer is necessary or that other materials may be applied to the exposed surface including, but not limited to coatings, paints, cellulosic materials such as paper, etc. so long as the material forms a sufficient bond with the polymer of to which it is applied.

FIGS. 1-3 present one embodiment of an exterior corner bead 1 having two flanges 2 folded about longitudinal axis 6 in the fold region 3 at an angle of about 86°. This particular embodiment employs a plurality of staggered rows of elliptical through holes 8 in the outer region of each flange 2, i.e., that region closest to the longitudinal edges of the flanges. FIG. 2 shows a cross-sectional view of the exterior corner bead of FIG. 1 along line 2-2. As an exterior corner bead, the exposed surface 4 faces away from the angle of the fold whereas the bonding surface 5 faces the angle of the fold. FIG. 3 shows a close up view of a portion of the cross-sectional view depicted by bubble A in FIG. 2. As shown, the corner bead comprises a thermoplastic polymer strip 10, preferably a PVC strip, having applied to both surfaces thereof a cured curable adhesive 12 which has embedded or partially embedded therein a plurality of fibers 14. On the exposed surface, the fibers protrude from the surface of the cured adhesive. On the bonding surface, those portions of the fibers not embedded in the cured adhesive are embedded in a water activated adhesive 16, e.g., EG2500 gum sealant available from the H.B. Fuller Company of St. Paul, Minn., while lies as a thin film atop the cured adhesive 12. In use, one simply applies water to the inner surface of the folded corner bead, i.e., the bonding surface 5, and, following a short wait, applies the same to an exterior corner of wallboard. The water activated adhesive will firmly and strongly bond to the paper outer layer of the wallboard.

FIGS. 4-7 present an embodiment of an interior corner bead 21 having two flanges 22 folded about longitudinal axis 26 in the fold region 23. Like the exterior corner bead of FIG. 1, this embodiment also employs a plurality of staggered rows of elliptical through holes 28 in the outer regions of the flanges 22. FIG. 5 shows the cross-sectional view of the corner bead of FIG. 4 along line 5-5. As an interior corner bead, the bonding surface 25 faces away from the angle of the fold whereas the exposed surface 24 faces the angle of the fold. FIG. 6 shows a close up view of a portion of the cross-section view depicted by bubble B in FIG. 5. As shown, the corner bead comprises a thermoplastic polymer strip 30, preferably a PVC strip, having applied to both surfaces thereof a cured adhesive 32 which has embedded or partially embedded therein a plurality of fibers 34. On the exposed surface 24, the fibers protrude from the surface of the cured adhesive. On the bonding surface 25, those portions of the fibers not embedded in the cured adhesive are embedded in a water activated adhesive 36 which lies as a thin film atop the cured adhesive 32. In use, one simply applies water to the outer surface of the folded corner bead, i.e., the bonding surface 25, and, following a short wait, applies the same to an interior corner of wallboard. The water activated adhesive will firmly and strongly bond to the paper outer layer of the wallboard.

Additionally, in this particular embodiment, as shown more clearly in FIG. 7, the fold region 23 of the corner bead 21 of FIG. 4, has an extended protrusion, the peak of which corresponds to the longitudinal axis 26 and fold line of the corner bead. The protrusion has associated therewith a slight indentation 40 parallel to and offset from the longitudinal axis. Additionally, as shown, in this particular embodiment, the thickness of the corner bead in the fold region 23 is thinner than that in the flange elements 22: the transition in thickness generally occurring at the indentation point.

FIG. 8 depicts yet another iteration of an exterior corner bead according to the present teachings. Here the polymeric body 53 has both a recess 55, most typically an embossed recess, along the longitudinal axis and a taper in the flange thickness as one moves perpendicular to the longitudinal axis from the edge of the recess to the outermost longitudinal edge of the flanges 52. The exposed surface of the corner bead has applied thereto a cured adhesive 54 having embedded therein fibers, most of which also have a portion which extends from the surface of the cured adhesive (not shown). The bonding side of the corner bead has a cured adhesive 54 on the surface of each flange, but not in the fold region, depicted by the arrow 59, in which are embedded fibers (not shown), most of which also have a portion which extends from the surface of the cured adhesive into a layer of a water activated adhesive 58 which overlays the cured adhesive. In this particular embodiment, there are no holes through the flanges and adhesion of the corner bead to the wallboard is reliant upon the water activated adhesive and the drywall compound applied across the flanges and the adjoining wallboard.

FIG. 9 depicts another iteration of a corner bead 60 wherein there is a raised, rounded protrusion 62 along the centerline axis and the flanges 65 have a grid of circular through holes 64.

FIG. 10 depicts a cross-sectional view of a exterior corner bead 70 having exposed surface 73 and bonding surface 76 on flanges 72 wherein the protrusion 74 along the longitudinal axis has deposited therein a bead of an adhesive, sealant or caulking composition 75, e.g., a polyurethane. This composition provides additional adherence of the corner bead to the wallboard corner and serves as a protective guard, adding strength and integrity to the corner edge and aiding in preventing deformation of the finished corner from, e.g., blunt forces as in moving furniture, pulling a vacuum cleaner, etc.

Finally, FIG. 11 presents a schematic diagram of a continuous process 80 employed to manufacture the corner beads of the present invention. In this particular process, a spool of stock, extruded, preformed polymeric strip material 81 is employed. The polymeric strip material 86 then passes through an adhesive application station 82 where a plurality of spray heads 83 apply a thin film of a curable adhesive to both sides of the polymeric strip material. Subsequently, the curable adhesive coated polymeric strip material moves to a fiber dusting station 84 where the fibers are applied to both surfaces, with at least a portion thereof becoming adhered to and/or partially immersed in the uncured adhesive. The strip material then proceeds to a curing station 85 where the curable adhesive is cured, thereby securely adhering and/or partially embedding the fibers in the cured adhesive. In this particular process, heaters 87 blow warm air through the cure chamber 88. The residence time in the cure chamber is sufficient to allow full cure of the curable adhesive or sufficiently activate the cure such that the curable adhesive is fully cured or nearly so before further processing.

Subsequently, as the polymeric strip continues to progress through the process, a water activated adhesive is applied to what is to be the bonding surface of the corner bead at a second adhesive application station 89. In this particular process, the water activated adhesive is sprayed onto the bonding surface of the polymeric strip. Since the film of water activated adhesive is so thin, simple air evaporation is sufficient to set/dry the applied water activated adhesive. However, though not shown, it is most typically desired to add fans, with or without heat, to hasten the drying time of the water activated adhesive. At this point, the corner bead material 91 is a fully constructed: no additional materials are added.

However, as also shown in FIG. 11, in this particular process further processing is to be performed to convert the corner bead material to a final product to be sold. Specifically, as shown, the corner bead material 91 is then passed through a plurality of print rollers 90 where desired indicia are applied to one or both surfaces of the corner bead material. Next, the corner bead material is passed through an embossing station 92 where a plurality of press rollers emboss the corner bead material along its longitudinal axis, thinning the corner bead material while concurrently adding an indentation so as to provide a distinct peak or protrusion as depicted in FIG. 7. The embossing provides a neat, linear fold seam to the corner bead as well as thins the same so as to make folding easier. Thereafter, the corner bead passes through a punch station 94 where punch dies punch a plurality of holes into the outer regions of the flanges of the corner bead material.

Finally, the finished corner bead 95 proceeds to a winding station 99 where the finished product is wound, one winding directly atop the other, on a spool or mandrel 96. The corner bead is cut once the desired length of material is on the given spool or mandrel and the spool or mandrel replaced with a new one to continue winding.

While the corner beads, their production and use, of the present specification have been described with respect to specific embodiments and figures, it should be appreciated that the present teachings are not limited thereto and other embodiments utilizing the concepts expressed herein are intended and contemplated without departing from the scope of the present teaching. Thus, the true scope of the present teachings is defined by the claimed elements and any and all modifications, variations, or equivalents that fall within the spirit and scope of the underlying principles set forth herein.

I claim:

1. A corner bead for use in wallboard applications comprising:
a) a thin, elongated polymeric strip-like body having two surfaces, a bonding surface for mating with a wallboard substrate and an exposed surface facing away from the wallboard when mated, said polymeric body having a longitudinal axis running the length of the polymeric body and the polymeric body into a pair of flanges and about which the polymeric body is folded or foldable,
b) a layer of discrete fibers adhered to at least a portion of the bonding surface and, optionally, the expose surface of the polymeric body, and
c) a water activated adhesive applied to the layer of discrete fibers on the bonding surface.

2. The corner bead of claim 1 wherein the polymeric body is formed from a thermoplastic polymer.

3. The corner bead of claim 2 wherein the thermoplastic polymer is a polypropylene, polyethylene, polystyrene, nylon, polyether, polyester, polycarbonate, vinyl polymer, a copolymer of monomers of the foregoing, or a polymer blend of any two or more of the foregoing.

4. The corner bead of claim 1 wherein the fibers are adhered to the polymeric body by a curable adhesive which is cured following application of the adhesive and fibers to the surface of the polymeric body.

5. The corner bead of claim 4 wherein at least a portion of the fibers are embedded in the cured curable adhesive.

6. The corner bead of claim 4 wherein the layer of fibers is applied by first applying a layer of a curable adhesive to at least of portion of the surface of the polymer body, dusting the layer with a layer of fibers whereby at least a portion of the fibers are partially embedded in the curable adhesive, and curing the curable adhesive.

7. The corner bead of claim 4 wherein the curable composition is compatible with or has good adherence to the polymer of the polymeric body.

8. The corner bead of claim 1 wherein the fibers are true fibers, fibrils, flocs, or tufts or combinations thereof.

9. The corner bead of claim 1 wherein the fibers are selected from natural fibers, synthetic fibers and combinations thereof.

10. The corner bead of claim 1 wherein the fibers are water absorbing, water wicking, or both.

11. The corner bead of claim 1 wherein fibers are partially entrained in or embedded in the water activated adhesive.

12. The corner bead of claim 1 wherein the water activated adhesive is a water soluble adhesive.

13. The corner bead of claim 1 wherein the polymeric body is embossed along the longitudinal axis.

14. The corner bead of claim 1 wherein the polymeric body has a protrusion extending along the longitudinal axis.

15. The corner bead of claim 1 wherein a plurality of holes are present in the flanges.

16. The corner bead of claim 1 wherein the layer of fibers is present on both the exposed surface and the bonding surface.

17. A method of making a corner bead comprising the steps of:
a) providing a thin, elongated polymeric strip-like body having two surfaces, a bonding surface for mating with a wallboard substrate and an exposed surface facing away from the wallboard when mated, said polymeric body having a longitudinal axis running the length of the polymeric body and dividing the polymeric body into a pair of flanges and about which the polymeric body is folded or foldable,
b) forming on at least a portion of the surfaces of said polymeric body a layer of discrete fibers adhered to said surfaces, and
c) applying a layer of a water activated adhesive over at least a portion of said layer of discrete fibers.

18. The method of claim 17 wherein the layer of discrete fibers adhered to the surfaces is formed by first applying a layer of a curable adhesive to at least of portion of the surface of the polymer body, dusting the layer of the curable adhesive with a layer of fibers whereby at least a portion of the fibers are partially embedded in the curable adhesive, and curing the curable adhesive.

19. The method of claim 17 wherein the product resulting from steps (a), (b) and (c) is embossed along the longitudinal axis.

20. The method of claim 17 wherein the product resulting from steps (a), (b) and (c) is subjected to a thermoforming step whereby a protrusion is imparted to the longitudinal axis.

21. The method of claim 17 wherein the product resulting from steps (a), (b) and (c) is folded along the centerline axis to a predetermined angle.
